(19) United States
(12) Patent Application Publication
(10) Pub. No.: US 2026/0089612 A1
(43) Pub. Date: Mar. 26, 2026

(54) COMMUNICATION APPARATUS, COMMUNICATION METHOD, AND RECORDING MEDIUM

(71) Applicant: CASIO COMPUTER CO., LTD., Tokyo (JP)

(72) Inventors: Munetaka SEO, Tokyo (JP); Takashi ITO, Tokyo (JP); Shuhei UCHIDA, Tokyo (JP); Hiroaki OTSUBO, Tokyo (JP); Takeshi MATSUE, Tokyo (JP)

(21) Appl. No.: 19/332,543

(22) Filed: Sep. 18, 2025

(30) Foreign Application Priority Data
Sep. 20, 2024 (JP) 2024-164288

(51) Int. Cl. H04W 48/16; H04W 4/80; H04W 76/15

(52) U.S. Cl. CPC H04W 48/16; H04W 4/80; H04W 76/15

(57) ABSTRACT

A communication apparatus for performing communication with one or more external apparatuses in accordance with one wireless communication method includes a processor and a non-transitory storage medium storing a program that causes the processor to: perform, by transmitting search signals based on predetermined transmission timing rules in first communication that is an external apparatus search mode of the wireless communication method, communication with the one or more external apparatuses transmitting scan signals based on the predetermined transmission timing rules; and perform transmission or reception of contents data to or from the one or more external apparatuses by the first communication.

### CROSS-REFERENCE TO RELATED APPLICATIONS

This application is based on and claims the benefit of priority from Japanese Patent Application No. 2024-164288, filed on Sep. 20, 2024, the content of which is incorporated herein by reference.

### BACKGROUND OF THE INVENTION

### Field of the Invention

The present disclosure relates to a communication apparatus, a communication method, and a recording medium.

### Related Art

Wristwatch-type smartwatches have been used as convenient communication terminals equipped with a function of, by being connected to a smartphone by wireless communication, notifying a user of a call to the smartphone and arrival of an email, a call function, and the like. In general, a smartwatch and a smartphone are connected by wireless communication of the Bluetooth Low Energy (hereinafter “BLE”) communication standard with relatively low power consumption. In BLE, a child unit called a peripheral transmits a wireless signal called an advertising signal in a predetermined cycle. A parent unit called a central executes scanning at predetermined intervals and, when detecting the advertising signal, requests pairing of the child unit to establish wireless connection.

For example, Japanese Unexamined Patent Application, Publication No. 2019-016866 proposes the following configuration for communicating with multiple external apparatuses. In a case where a Wi-Fi connection is established with a first external apparatus while the first external apparatus is connected via a Bluetooth Low Energy (BLE) connection, the BLE connection is terminated, and subsequently, a BLE connection is established with a second external apparatus.

### SUMMARY OF THE INVENTION

One aspect of the present disclosure is a communication apparatus for performing communication with one or more external apparatuses in accordance with one wireless communication method, the communication apparatus including a processor and a non-transitory storage medium storing a program that causes the processor to: perform, by transmitting search signals based on predetermined transmission timing rules in first communication that is an external apparatus search mode of the wireless communication method, communication with the one or more external apparatuses transmitting scan signals based on the predetermined transmission timing rules; and perform transmission or reception of contents data to or from the one or more external apparatuses by the first communication.

Further features of the present invention will become apparent from the following description of exemplary embodiments (with reference to the attached drawings).

### BRIEF DESCRIPTION OF THE DRAWINGS

FIG. 1A is a schematic diagram illustrating an overall configuration of a communication system in one embodiment of the present invention;

FIG. 1B is a schematic diagram illustrating the overall configuration of the communication system in the one embodiment of the present invention;

FIG. 2 is a block diagram showing a hardware configuration example of a mobile radio apparatus in the one embodiment of the present invention;

FIG. 3 is a block diagram showing a hardware configuration example of a mobile terminal apparatus in the one embodiment of the present invention;

FIG. 4 is a block diagram showing a functional block configuration example of the mobile radio apparatus in the one embodiment of the present invention;

FIG. 5 is a block diagram showing a functional block configuration example of the mobile terminal apparatus in the one embodiment of the present invention;

FIG. 6A is a schematic diagram showing an example of a protocol for performing advertising communication between the mobile radio apparatus and the mobile terminal apparatus in the one embodiment of the present invention;

FIG. 6B is a schematic diagram showing a state in which the mobile radio apparatus and the mobile terminal apparatus in the one embodiment of the present invention establish pairing and execute large-volume data communication;

FIG. 7 is a diagram showing an example of an advertising signal execution table specifying the protocol shown in FIG. 6A;

FIG. 8 is a diagram showing an example of an apparatus address table; and

FIG. 9 is a sequence diagram illustrating a connection sequence in the communication system in the one embodiment of the present invention.

### DETAILED DESCRIPTION OF THE INVENTION

The present invention will be described below with reference to accompanying drawings based on an embodiment thereof.

### Background of the Present Embodiment

First, in order to help understanding of the present embodiment, the background thereof will be described. In general, in the case of wirelessly connecting a smartwatch (a communication apparatus) and a smartphone (an external apparatus) by BLE; the smartwatch transmits an advertising signal, which is a search signal, as a peripheral; the smartphone performs wireless signal scanning as a central to detect the advertising signal from the smartwatch; and, thereby, wireless connection is established.

A problem in the connection mode of the smartwatch and the smartphone described above is that the smartwatch as a peripheral can connect to only one smartphone as a central at a time due to the specifications of BLE. Today, it is not uncommon for an individual to use two smartphones, a private smartphone and a business smartphone. In this case, the smartwatch can only connect to one of the smartphones. In order to connect the smartwatch, which has been used being connected to the private smartphone, to the business smartphone and use it, it is necessary to perform a connection procedure in BLE again.

Here, attention will be paid to advertising communication used to search for an apparatus between a peripheral and a central. The peripheral transmits an advertising signal at predetermined time intervals to notify the central of its existence. In general, the central that has received the advertising signal transmits data including its own BLE address and the like, to the peripheral, which is the advertising signal transmission source, to request pairing. The peripheral that has received the pairing request from the central transmits data including its own BLE address and the like, to the central, which is the pairing request source, to complete pairing. After that, it becomes possible for the paired peripheral and central to perform data communication in accordance with the BLE specifications by GATT communication.

As described before, when being paired with one central, a peripheral cannot perform BLE connection with another central. However, even when a peripheral is not paired with any central, it can perform communication with two or more centrals by advertising communication. In order to realize such data exchange using advertising communication, a protocol for a peripheral to transmit an advertising signal to particular centrals is specified in the present embodiment.

By doing so, by a peripheral transmitting an advertising signal in accordance with the specified protocol, centrals existing within a range where communication with the peripheral is possible can reply with predetermined data to the peripheral. It is assumed that a payload up to 255 octets can be transmitted in BLE5 by advertising communication, for example, at 100 ms or 1 s time intervals. Though the data amount is small in comparison with normal BLE connection, the advertising communication can, for example, be utilized to transmit notification data about email arrival and the like from a smartwatch that is a peripheral to a smartphone as a central. In the case of executing transmission of a larger amount of data from a central, the central concerned can make a pairing request to a peripheral. Details of such communication will be described later in detail.

### <Configuration of Communication System>

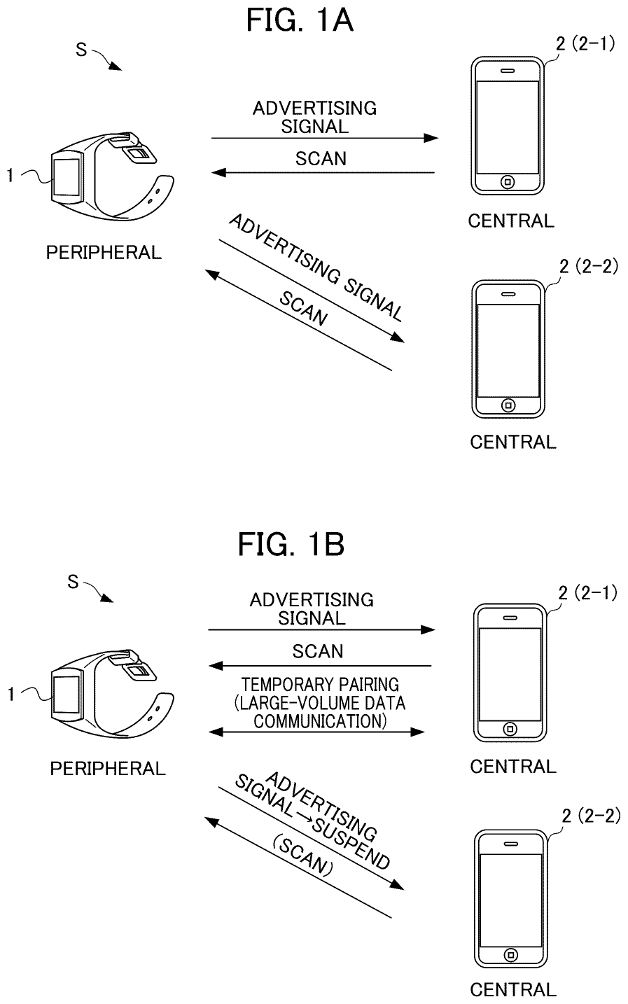

First, a configuration of a communication system according to the present embodiment will be described with reference to FIGS. 1A and 1B. FIGS. 1A and 1B are schematic diagrams illustrating an overall configuration of the communication system in the present embodiment. A communication system S includes a mobile radio apparatus 1 as a communication apparatus and mobile terminal apparatuses 2 as external apparatuses, and the mobile radio apparatus 1 and the mobile terminal apparatuses 2 can be BLE-connected. The mobile radio apparatus 1 of the present embodiment is configured as a wristwatch-type electronic apparatus used by a user, being fitted to his forearm, a so-called smartwatch. The mobile radio apparatus 1 has standard time display and time keeping functions, such as time display, alarm, and timer. The mobile radio apparatus 1 may be additionally equipped with various kinds of measurement functions including activity measurements such as temperature measurement, atmospheric pressure measurement, heart rate measurement, and step counting. Or alternatively, the mobile radio apparatus 1 may be an electronic apparatus such as an activity meter without the time display function as a watch or may be a simple analog watch, digital watch, or the like equipped with a communication function.

The mobile terminal apparatuses 2 are typically smartphones equipped with a call function. The mobile radio apparatus 1 as a smartwatch functions as a wireless terminal of the mobile terminal apparatuses 2 by being wirelessly connected to the mobile terminal apparatuses 2 as smartphones. Specifically, it is possible to receive notifications to the mobile terminal apparatuses 2, such as incoming phone calls, reception of emails, and arrival of schedule time by the mobile radio apparatus 1. The mobile terminal apparatuses 2 are not limited to smartphones, and other mobile terminals such as tablet terminals equipped with a wireless communication function or other electronic apparatuses such as notebook computers can be assumed. In the case of distinguishing the mobile terminal apparatuses 2 individually, they will be referred to as the mobile terminal apparatuses 2A and 2B.

As shown in FIG. 1A, the mobile radio apparatus 1 functions as a peripheral and transmits an advertising signal at predetermined time intervals in this embodiment. Specifically, the two mobile terminal apparatuses 2A and 2B to be connection targets function as centrals and execute advertising signal scanning with a predetermined protocol. When the mobile terminal apparatuses 2A and 2B detect an advertising signal from the mobile radio apparatus 1, the mobile radio apparatus 1 transmits predetermined data to the mobile terminal apparatuses 2A and 2B. Thus, the mobile radio apparatus 1 as a peripheral can perform data communication with the mobile terminal apparatuses 2A and 2B by advertising communication executed with the predetermined protocol.

FIG. 1B shows a state in which the mobile radio apparatus 1 is paired with one mobile terminal apparatus 2A and is executing large-volume data communication. The mobile terminal apparatus 2A that is a central makes a pairing request to the peripheral for large-volume data transmission. As for the mobile terminal apparatus 2B that is another central, since reception of an advertising signal is interrupted, the mobile terminal apparatus 2B enters a standby state of waiting for restart of reception of an advertising signal. It becomes possible for the mobile radio apparatus 1 paired with the mobile terminal apparatus 2A as a peripheral to perform large-volume data communication by BLE GATT communication.

### <Hardware Configuration Example of Mobile Radio Apparatus 1>

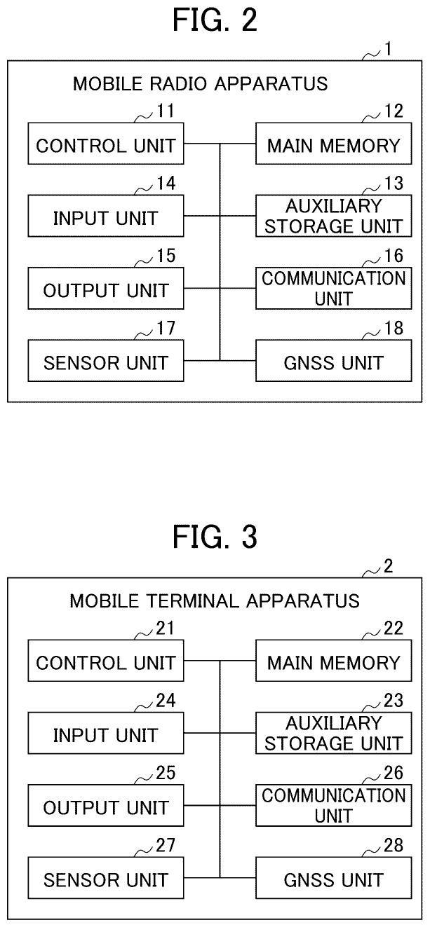

Next, the configuration of the mobile radio apparatus 1 in the present embodiment will be described. FIG. 2 is a block diagram illustrating a hardware configuration of the mobile radio apparatus 1 in the one embodiment of the present disclosure. As shown in FIG. 2, the mobile radio apparatus 1 in the present embodiment includes a control unit 11, a main memory 12, an auxiliary storage unit 13, an input unit 14, an output unit 15, a communication unit 16, a sensor unit 17, and a GNSS unit 18.

Each of the hardware components illustrated in FIG. 2 will be described. The control unit 11 is configured with a processor that performs processing such as various kinds of calculations and control required for operation of the mobile radio apparatus 1. The control unit 11 can also be referred to as a processor. The processor constituting the control unit 11 is, for example, a central processing unit (CPU), a micro processing unit (MPU), a System on a Chip (SoC), a digital signal processor (DSP), a graphics processing unit (GPU), an application specific integrated circuit (ASIC), a programmable logic device (PLD), a field-programmable gate array (FPGA), or the like, or a combination thereof. Furthermore, the control unit 11 may be a combination of such a processor and a hardware accelerator or the like.

The main memory 12 stores programs such as firmware, system software, and application software and also functions as a work area that is temporarily used to perform various kinds of processing. The main memory 12 is configured, for example, with a read-only memory (ROM) which is a non-transitory storage medium, a random access memory (RAM) which is a transitory storage medium, and the like.

The auxiliary storage unit 13 stores data such as contact information, such as phone numbers and email addresses, and various application programs. The auxiliary storage unit 13 is configured with a semiconductor memory or the like.

The input unit 14 is configured, for example, with a touch panel, various kinds of buttons such as keys, a microphone, and the like, and accepts an operation by the user. The output unit 15 is configured with a display mounted with the touch panel described above to display images, a speaker or the like that amplifies sound, and outputs images and sound.

The communication unit 16 controls wireless communication performed by the mobile radio apparatus 1 with an external apparatus. The communication unit 16 includes, for example, a BLE module that supports wireless communication with the mobile terminal apparatuses 2 in the present embodiment. The BLE module causes the mobile radio apparatus 1 to function as a central or peripheral of the BLE communication standard. The communication unit 16 may also include network connection equipment such as a subscriber identity module (SIM) card and a network adaptor, and wireless communication equipment based on communication standards such as Wireless Fidelity (Wi-Fi) (registered trademark) and Near Field Communication (NFC). Furthermore, the communication unit 16 may include a Bluetooth Classic module instead of the BLE module. That is, the mobile radio apparatus 1 may perform communication with the mobile terminal apparatuses 2 in accordance with the Bluetooth Classic Wireless communication method.

The sensor unit 17 includes various kinds of sensors that detect the state and movement of the user. The sensor unit 17 is configured, for example, with an acceleration sensor, an angular acceleration sensor, a geomagnetic sensor, a pressure sensor, a heart rate sensor, and the like. The acceleration sensor, the angular acceleration sensor, the geomagnetic sensor, and the pressure sensor can cause the sensor unit 17 to function as a behavior detection unit for detecting a movement of the user and function as a position identification unit together with the GNSS unit 18 described later. Furthermore, the heart rate sensor can cause the sensor unit 17 to function as a biological information acquisition unit for acquiring the heart rate of the user as biological information.

The GNSS unit 18 is a positioning information acquisition unit for acquiring position information. GNSS is an abbreviation of Global Navigation Satellite System, and the GNSS unit 18 is a satellite positioning apparatus that uses a satellite positioning system such as the Global Positioning System (GPS). The GNSS unit 18 is configured with an antenna and electronic parts, acquires positioning satellite signals transmitted from a plurality of positioning satellites, and identifies its own position.

### <Hardware Configuration Example of Each Mobile Terminal Apparatus 2>

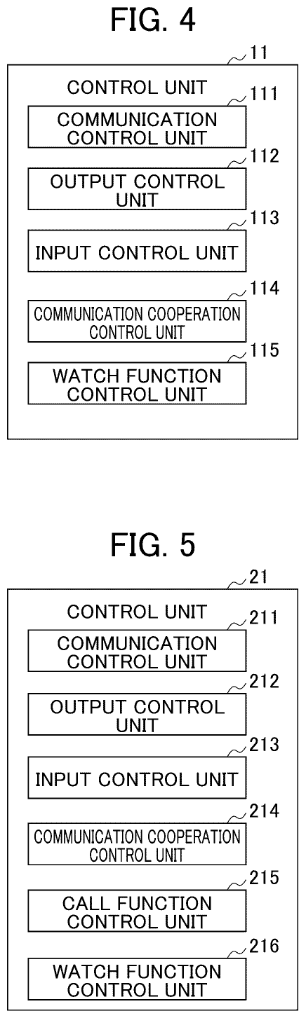

Next, the configuration of each mobile terminal apparatus 2 in the present embodiment will be described. As shown in FIG. 4, each mobile terminal apparatus 2 in the present embodiment includes a control unit 21, a main memory 22, an auxiliary storage unit 23, an input unit 24, an output unit 25, a communication unit 26, a sensor unit 27, and a GNSS unit 28. Since the hardware configuration of the mobile terminal apparatus 2 is equal to that of the mobile radio apparatus 1 as a computer equipped with a communication function, duplicate description of each component will be omitted.

### <Functional Configuration Example of Mobile Radio Apparatus 1>

Next, functions realized by the control unit 11 of the mobile radio apparatus 1 will be described. FIG. 4 is a block diagram illustrating functions realized by the control unit 11 of the mobile radio apparatus 1 in the one embodiment of the present disclosure. The control unit 11 of the present embodiment includes a communication control unit 111, an output control unit 112, an input control unit 113, a communication cooperation control unit 114, and a watch function control unit 115.

The communication control unit 111 executes a process for the mobile radio apparatus 1 to communicate with an external apparatus via the communication unit 16. For example, as for the present embodiment, the communication control unit 111 performs control of wireless communication with the mobile terminal apparatuses 2 based on the BLE communication standard. Specifically, the communication control unit 111 controls processes for the BLE module provided in the communication unit 16 to transmit an advertising signal as a peripheral with a predetermined protocol and to execute pairing in response to a pairing request from a central. The time interval of transmitting the advertising signal can be appropriately set, for example, to 100 ms or the like.

The output control unit 112 executes a process for displaying an image on the screen of the output unit 15. For example, the output control unit 112 executes a process for displaying any of watch displays in various modes and various kinds of notification display images from the connected mobile terminal apparatuses 2 on the screen of the output unit 15. Furthermore, the output control unit 112 performs a process for causing sound, such as voice of call voice, various kinds of notifications, and an alarm, from the mobile terminal apparatuses 2 connected through the output unit 15 to be outputted.

The input control unit 113 executes a process for accepting an operation of the input unit 14 by the user. For example, the input control unit 113 executes a process for accepting an input operation the user has executed via the input unit 14 using an operation screen displayed on the screen of the output unit 15 or keys or buttons for input.

The communication cooperation control unit 114 enables the various kinds of applications implemented in the mobile radio apparatus 1 to operate in cooperation with the communication control unit 111. For example, when a pedometer application requests notification of step count data, the communication cooperation control unit 114 sends the step count data to the communication control unit 111, including the step count data in advertising communication data.

In the smartwatch as the mobile radio apparatus 1, the watch function control unit 115 controls functions of the mobile radio apparatus 1 as a watch, for example, the time display, alarm, and timer functions.

### <Functional Configuration Example of Each Mobile Terminal Apparatus 2>

Next, functions realized by the control unit 21 of each mobile terminal apparatus 2 will be described. FIG. 5 is a block diagram illustrating functions realized by the control unit 21 of each mobile terminal apparatus 2 in the one embodiment of the present disclosure. The control unit 21 of the present embodiment includes a communication control unit 211, an output control unit 212, an input control unit 213, a communication cooperation control unit 214, a call function control unit 215, and a watch function control unit 216.

The communication control unit 211 executes a process for the mobile terminal apparatus 2 to communicate with an external apparatus such as the mobile radio apparatus 1 via the communication unit 26. For example, as for the present embodiment, the communication control unit 211 performs control of wireless communication with the mobile radio apparatus 1 based on the BLE communication standard.

Specifically, the communication control unit 211 controls processes for the BLE module provided in the communication unit 26 to, as a central, transmit/receive an advertising signal to/from the mobile radio apparatus 1 as a peripheral with a predetermined protocol and to execute a large-volume data communication process with the mobile radio apparatus 1 that is a peripheral.

The output control unit 212 executes a process for displaying an image on the screen of the output unit 25. For example, the output control unit 212 executes a process for displaying output display images of various kinds of application programs installed in the mobile terminal apparatus 2 as a smartphone to operate, on the screen of the output unit 25. Furthermore, the output control unit 212 performs a process for causing sound, such as voice of a call, various kinds of notifications, and an alarm to be outputted through the output unit 25.

The input control unit 213 executes a process for accepting an operation of the input unit 24 by the user. For example, the input control unit 213 executes a process for accepting an input operation the user has executed via the input unit 24 using the operation screen displayed on the screen of the output unit 25 or keys or buttons for input.

The communication cooperation control unit 214 is a function unit that enables the various kinds of applications implemented in the mobile terminal apparatus 2 to operate in cooperation with the communication control unit 211. For example, any of the various kinds of applications operating in the mobile terminal apparatus 2 requests transition from data communication by transmission/reception of an advertising signal to large-volume data communication based on the normal BLE communication standard, for example, by GATT communication, the communication cooperation control unit 214 requests the communication control unit 211 to execute a process for transitioning to GATT communication. As the case of requesting transition to large-volume data communication, a case of an application requesting start of communication of large-volume data such as sound data in the mobile terminal apparatus 2, a case of update of an application, firmware, or the like implemented in the mobile radio apparatus 1 being requested, or the like is given.

In the smartphone as the mobile terminal apparatus 2, the call function control unit 215 controls the function of the mobile terminal apparatus 2 as a telephone. In addition, the control unit 21 can be equipped with a function of controlling various kinds of pieces of hardware, such as a camera, provided in the mobile terminal apparatus 2.

In the smartphone as the mobile terminal apparatus 2, the watch function control unit 216 controls functions of the mobile terminal apparatus 2 as a watch, for example, the time display, alarm, and timer functions.

The functions of the communication cooperation control unit 214 can be realized by installing an application program for managing and controlling information transmission/reception to/from and operation cooperation with the mobile radio apparatus 1, into the mobile terminal apparatus 2 embodied as a smartphone or the like.

### <Example of Protocol for Advertising Communication>

In the present embodiment, the mobile radio apparatus 1 that is a peripheral and the two or more mobile terminal apparatuses 2 that are centrals are continuously performing data communication by advertising communication as described above.

### (1) Protocol for Advertising Communication

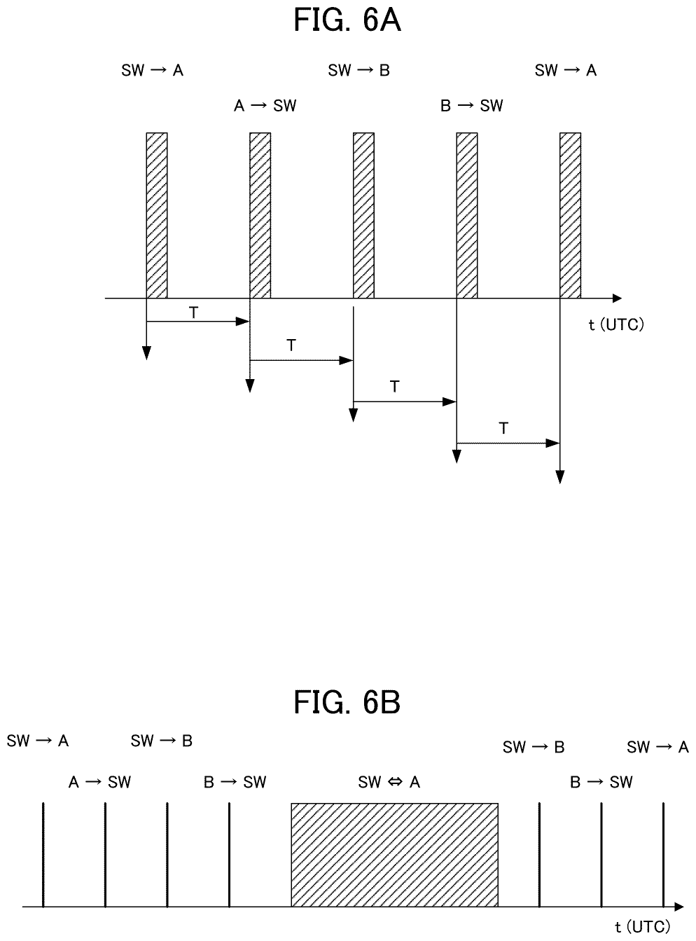

FIG. 6A schematically shows an example of a protocol for performing advertising communication between the mobile radio apparatus 1 that is a peripheral and the mobile terminal apparatuses 2 that are centrals.

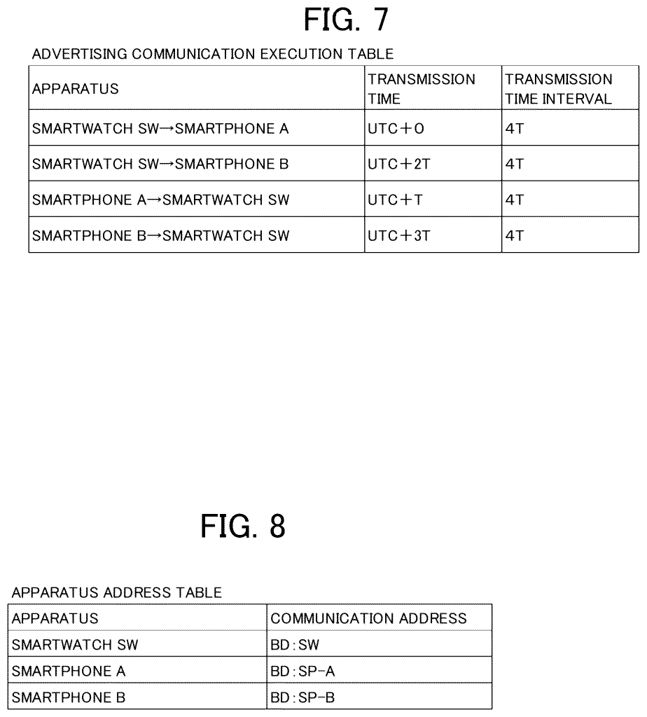

Here, a smartwatch SW that is a peripheral and two smartphones A and B that are centrals are performing communication at predetermined timings based on Coordinated Universal Time (UTC). In the example of FIG. 6A, at a timing when time clocked by the watch function control unit 115 and the watch function control unit 216 is UTC=0, the smartwatch SW transmits an advertising signal to the smartphone A. After that, at time intervals T, an advertising signal is transmitted from the smartphone A to the smartwatch SW, from the smartwatch SW to the smartphone B, and from the smartphone B to the smartwatch SW in that order. FIG. 7 shows an example of an advertising communication execution table specifying a protocol for advertising communication. In the advertising communication execution table, as transmission times, transmission of an advertising signal from the smartwatch SW to the smartphone A, from the smartphone A to the smartwatch SW, from the smartwatch SW to the smartphone B, and from the smartphone B to the smartwatch SW, occurs every time intervals T from time deference as reference time UTC=0. The communication control unit 111 of the mobile radio apparatus 1 and the communication control unit 211 of each mobile terminal apparatus 2 perform transmission at predetermined timings. As shown in FIG. 8, in an apparatus address table, communication addresses of the mobile radio apparatus 1 (the smartwatch SW) and the mobile terminal apparatuses 2 (the smartphones A and B) in BLE communication are stored. Therefore, the communication control units 111 and 211 can identify from which apparatus a received advertising signal has been transmitted.

For example, when the user of the smartwatch SW performs BLE pairing between the smartwatch SW and one or more smartphones he owns, the address of each smartphone, for example, an ID of the BLE communication standard or a MAC address can be acquired and stored in the apparatus address table as unique identification information.

The advertising communication execution table can be completed, for example, by writing identification information about a detected external apparatus into a table specifying that, in the smartwatch SW, data transmission/reception is executed in order of reception of a scan signal from an external apparatus, transmission of a search signal, and reception of a scan signal from another external apparatus, at predetermined time intervals, for example every second, after the search signal being transmitted from the smartwatch SW first at the timing of UTC=0, as a sequence for contents data communication by advertising communication. Or alternatively, an interface may be equipped which enables the user to set communication timings for smartphones connected to the smartwatch SW.

### (2) Execution of Large-Volume Data Communication

FIG. 6B schematically shows a state in which the mobile radio apparatus 1 (the smartwatch SW) that is a peripheral and the mobile terminal apparatus 2 (the smartphone A) that is a central establish pairing and execute large-volume data communication. In the example of FIG. 6B, a state is shown in which, while advertising communication is being executed at timings based on UTC similar to FIG. 6A, the smartphone A makes a pairing request for transmission of large-volume data, to the smartwatch SW. The smartphone A and the smartwatch SW execute pairing, and, after that, data communication in accordance with the BLE specifications is executed by BLE GATT communication. Thereby, large-volume data that cannot be transmitted by advertising communication, for example, sound data is transmitted from the smartphone A to the smartwatch SW.

When the large-volume data communication is being executed, both of the smartphone A and the smartwatch SW suspend transmission of an advertising signal. Furthermore, since an advertising signal is not received from the smartwatch SW, the smartphone B similarly suspends transmission of an advertising signal.

The large-volume data communication ends, for example, by the smartwatch SW receiving a data transmission end notification from the smartphone A, and the smartwatch SW and the smartphones A and B return to execution of advertising communication with a predetermined protocol.

### <Wireless Communication Control Function in the Present Embodiment>

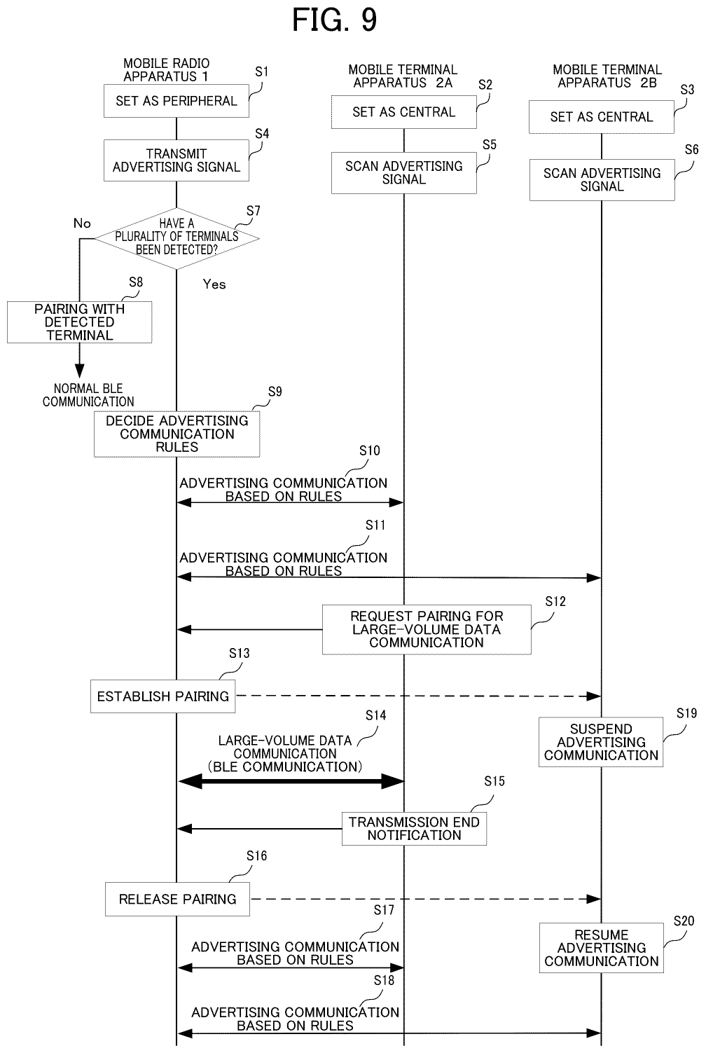

Next, a description will be made on a wireless communication connection process based on the BLE communication standard executed in the communication system S that includes the mobile radio apparatus 1 and the mobile terminal apparatuses 2 of the present embodiment. FIG. 9 shows a process procedure example of the wireless communication process executed in the communication system S of the present embodiment illustrated in FIGS. 1A and 1B, as a sequence diagram. The communication system S includes one mobile radio apparatus 1 and two mobile terminal apparatuses 2. Here, the two mobile terminal apparatuses 2 will be referred to as a mobile terminal apparatus 2A and a mobile terminal apparatus 2B.

The wireless communication control process illustrated in FIG. 9 is executed mainly by the communication control units 111 and 211 and the communication cooperation control units 114 and 214 of the mobile radio apparatus 1 and the mobile terminal apparatuses 2.

The wireless communication connection process sequence is continuously executed after the mobile radio apparatus 1 is powered on and starts operation.

At step S1, in the mobile radio apparatus 1, the communication control unit 111 is set to operate as a peripheral of the BLE communication standard. At step S2, the communication control unit 211 of the mobile terminal apparatus 2A is set to function as a central. At step S3, the communication control unit 211 of the mobile terminal apparatus 2B is set to function as a central.

At step S4, the mobile radio apparatus 1 transmits an advertising signal as a peripheral. At steps S5 and S6, the mobile terminal apparatuses 2A and 2B execute scanning of the advertising signal as centrals.

At step S7, the mobile radio apparatus 1 judges whether a plurality of mobile terminal apparatuses 2 have been detected. If only one mobile terminal apparatus 2 is detected (step S7: No), the mobile radio apparatus 1 establishes pairing of the BLE communication standard with the detected mobile terminal apparatus 2, and executes communication by normal BLE communication connection (step S8).

If a plurality of mobile terminal apparatuses 2 have been detected (step S7: Yes), the mobile radio apparatus 1 acquires an identification code, such as an ID of the BLE communication standard or a MAC address, as a communication address from each mobile terminal apparatus 2 through advertising communication, and generates rules for data communication to be executed with each mobile terminal apparatus 2 using advertising communication (hereinafter referred to as advertising communication rules) (step S9). The advertising communication rules are, for example, the rules specifying the timing of transmitting an advertising signal from the mobile radio apparatus 1 to each mobile terminal apparatus 2 and the timing of transmitting an advertising signal from each mobile terminal apparatus 2 to the mobile radio apparatus 1, which have been described with regard to FIG. 6A. Specifically, the communication cooperation control unit 114 of the mobile radio apparatus 1 generates the advertising communication execution table illustrated in FIG. 7 and the apparatus address table illustrated in FIG. 8 and stores them into a storage unit.

When the advertising communication execution table is generated, the mobile radio apparatus 1 shares it with the mobile terminal apparatuses 2A and 2B, and, after that, transmission/reception of contents data by advertising communication is executed (steps S10 and S11). Since the data packet capacity of advertising communication is limited to 31 bytes per packet, transmission/reception of contents data is used for an email, an incoming call notification, a notification from any of various kinds of applications such as the pedometer application, or the like the data amount of which is equal to or smaller than the limited data amount.

When it is judged in the mobile terminal apparatus 2A that execution of large-volume data communication is required for transmission of sound data, transmission of update data for an application program, or the like, pairing for communication in a second communication mode is requested of the mobile radio apparatus 1 (step S12). Note that the process of step S12 may be performed when it is judged that it is necessary to execute a predetermined data communication process. At step S13, the mobile radio apparatus 1 that has received the pairing request establishes pairing with the mobile terminal apparatus 2A, which is the request source, and, after that, large-volume data communication by GATT communication via BLE communication connection is executed (step S14). The mobile radio apparatus 1 is notified of end of the large-volume data communication from the mobile terminal apparatus 2A (step S15), and, thereby, the mobile radio apparatus 1 releases pairing with the mobile terminal apparatus 2A (step S16). After that, between the mobile radio apparatus 1 and the mobile terminal apparatus 2A, transmission/reception of contents data by advertising communication is resumed (steps S17 and S18).

On the other hand, while the large-volume data communication is being executed, the mobile radio apparatus 1 does not execute transmission/reception of contents data by advertising communication. Therefore, meanwhile, the mobile terminal apparatus 2B does not execute transmission/reception of contents data by advertising communication. Specifically, when the mobile radio apparatus 1 establishes pairing with the mobile terminal apparatus 2A at step S13, the mobile radio apparatus 1 suspends transmission of an advertising signal to the mobile terminal apparatus 2B, and advertising communication between the mobile terminal apparatus 2B and the mobile radio apparatus 1 is suspended (step S19). When the large-volume data communication between the mobile radio apparatus 1 and the mobile terminal apparatus 2A ends, and pairing between the mobile radio apparatus 1 and the mobile terminal apparatus 2A is released, the mobile radio apparatus 1 resumes transmission of an advertising signal to the mobile terminal apparatus 2B. Thereby, the mobile radio apparatus 1 resumes advertising communication with the mobile terminal apparatus 2B (step S20).

Note that, though the advertising communication rules are generated if a plurality of mobile terminal apparatuses 2 are detected (steps S7: Yes) in the example shown in FIG. 9, the advertising communication rules may be generated when only one mobile terminal apparatus 2 is detected (step S7: No), and the mobile radio apparatus 1 establishes pairing of the BLE communication standard with the detected mobile terminal apparatus 2 (step S8). For example, the mobile radio apparatus 1 may set the maximum number of mobile terminal apparatuses 2 connectable to the mobile radio apparatus 1 in advance and generate advertise communication rules of assigning timings of transmitting an advertising signal in order of mobile terminal apparatuses 2 that started connection to the mobile radio apparatus 1. For example, in the case of setting the maximum number of connectable mobile terminal apparatuses 2 to two, and one cycle to four T's, advertising communication rules may be set in which timings of the mobile radio apparatus 1 performing advertising communication with the first mobile terminal apparatus 2 are UTC+0 and UTC+T, and timings of the mobile radio apparatus 1 performing advertising communication with the second mobile terminal apparatus 2 are UTC+2T and UTC+3T.

According to the disclosure of Japanese Patent Laid-Open No. 2019-016866, a communication apparatus which performs communication with an external apparatus as a peripheral in accordance with BLE as one wireless communication method cannot communicate with another external apparatus in a state of being paired with the above external apparatus. In Patent Document 1, there is also a problem that, in the case of a first communication apparatus that plays the role of a central and a second communication apparatus that plays the role of a peripheral performing communication, the second communication apparatus that plays the role of a peripheral can connect only to the first communication apparatus when having been paired with the first communication apparatus, though Wi-Fi connection is possible. In comparison, according to the embodiment described above, when the mobile radio apparatus 1 detects a plurality of mobile terminal apparatuses 2 by advertising communication of the BLE communication standard, the mobile radio apparatus 1 can perform data transmission/reception by executing, for each mobile terminal apparatus 2, advertising communication at a predetermined timing, and it is possible to eliminate the data communication restrictions due to one-to-one pairing of the BLE communication standard. That is, according to the communication apparatus, the communication method, and the recording medium according to the present disclosure, it becomes possible for a communication apparatus that performs communication with an external apparatus in accordance with one wireless communication method to communicate with another external apparatus different from the external apparatus. Furthermore, it is possible to, when any of the mobile terminal apparatuses 2 requests large-volume data transmission/reception, perform pairing with the mobile radio apparatus 1 to execute the large-volume data transmission/reception based on the normal BLE communication standard. When the large-volume data transmission/reception ends, the mobile radio apparatus 1 can perform transmission/reception of contents data by executing advertising communication with each mobile terminal apparatus 2 at a predetermined timing.

As described above, in the present embodiment, the mobile radio apparatus 1 performs communication with the mobile terminal apparatuses 2 as external apparatuses in accordance with one wireless communication method, and the mobile radio apparatus 1 includes the control unit 11 that performs, by transmitting search signals based on predetermined transmission timing rules in first communication that is an external apparatus search mode of the one wireless communication method, communication with the mobile terminal apparatuses 2 transmitting scan signals based on the predetermined transmission timing rules, and performs transmission or reception of contents data to or from the mobile terminal apparatuses 2 by the first communication.

By doing so, the mobile radio apparatus 1 can execute contents data communication by the first communication, which is the external apparatus search mode of the one wireless communication method, with a plurality of mobile terminal apparatuses 2 based on the predetermined transmission timing rules. That is, it becomes possible for the mobile radio apparatus 1 performing communication with a mobile terminal apparatus 2 to communicate with another mobile terminal apparatus 2 different from the mobile terminal apparatus 2.

Furthermore, in the present embodiment the wireless communication method is Bluetooth Low Energy or Bluetooth Classic, and the first communication is advertising communication.

By doing so, it is possible to execute contents data communication by advertising communication of the BLE communication standard or the Bluetooth Classic communication standard.

Furthermore, in the present embodiment, when receiving scan signals from a plurality of mobile terminal apparatuses 2A and 2B in advertising communication, the control unit 11 can identify the mobile terminal apparatuses 2A and 2B and execute contents data communication with the mobile terminal apparatuses 2A and 2B by advertising communication, based on the predetermined transmission timing rules.

By doing so, the mobile radio apparatus 1 can execute transmission/reception of contents data to/from the plurality of mobile terminal apparatuses 2A and 2B by advertising communication.

Furthermore, in the present embodiment, when receiving scan signals from the plurality of mobile terminal apparatuses 2A and 2B in advertising communication, the control unit 11 may identify the mobile terminal apparatuses 2A and 2B, store the identified mobile terminal apparatuses 2A and 2B and the predetermined transmission timing rules into the storage unit, associating the mobile terminal apparatuses 2A and 2B with the predetermined transmission timing rules and, when receiving scan signals from the plurality of mobile terminal apparatuses 2A and 2B in advertising communication, read correspondence relationships between the mobile terminal apparatuses 2A and 2B and the predetermined transmission timing rules from the storage unit.

By doing so, when detecting the plurality of mobile terminal apparatuses 2A and 2B, the mobile radio apparatus 1 can quickly start transmission/reception of contents data by advertising communication.

Furthermore, in the present embodiment, when executing data communication faster than advertising communication or executing predetermined data communication with one of the plurality of mobile terminal apparatuses 2, the control unit 11 may establish connection, for example, by GATT communication of the BLE communication standard in order to execute the faster data communication with the one mobile terminal apparatus 2.

By doing so, the mobile radio apparatus 1 can execute large-volume data communication with the mobile terminal apparatus 2 when necessary.

Furthermore, in the present embodiment, it is possible for the control unit 11 not to execute transmission/reception of contents data with another mobile terminal apparatus 2 by advertising communication while executing the data communication with one mobile terminal apparatus 2 by the GATT communication of the BLE communication standard.

By doing so, the large-volume data communication can be smoothly executed because a communication load due to advertising communication does not occur during execution of the data communication.

Furthermore, in the present embodiment, it is possible for the control unit 11 to, upon completion of data communication with one mobile terminal apparatus 2 by GATT communication, resume contents data communication by advertising communication with the plurality of mobile terminal apparatuses 2 including the other mobile terminal apparatuses 2.

By doing so, it is possible to resume contents data communication between the mobile radio apparatus 1 and the plurality of mobile terminal apparatuses 2 in one wireless communication method.

Furthermore, in the present embodiment, in a communication method for the mobile radio apparatus 1 to perform communication with the mobile terminal apparatuses 2 in accordance with one wireless communication method, the control unit 11 of the mobile radio apparatus 1 performs, by transmitting a search signal based on predetermined transmission timing rules in first communication for search for external apparatuses in the one wireless communication method, communication with the mobile terminal apparatuses 2 transmitting a scan signal based on the predetermined transmission timing rules and transmission or reception of contents data to or from the mobile terminal apparatuses 2 by the first communication.

By doing so, effects similar to those of the mobile radio apparatus 1 according to the present embodiment described before can be obtained.

Furthermore, a recording medium in the present embodiment is a computer-readable non-transitory storage medium with a program stored therein, the program causing a computer equipped in the mobile radio apparatus 1 that performs communication with external apparatuses in accordance with one wireless communication method to execute a process as follows: performing, by transmitting search signals based on predetermined transmission timing rules in first communication for search for external apparatuses in the one wireless communication method, communication with the mobile terminal apparatuses 2 transmitting scan signals based on the predetermined transmission timing rules, and executing transmission or reception of contents data to or from the mobile terminal apparatuses 2 by the first communication.

By doing so, effects similar to those of the mobile radio apparatus 1 according to the present embodiment described before can be obtained.

It is possible to cause the series of processes described above to be executed by hardware or by software. In other words, the functional configuration of FIG. 5 is a mere exemplification, and the present invention is not particularly limited thereto. That is, it is sufficient if the mobile radio apparatus 1 is equipped with such functions that can execute the series of processes described above, and what functional blocks are used to realize the functions is not especially limited to the example of FIG. 5. Furthermore, one functional block may be configured with a single piece of hardware, a single piece of software, or a combination thereof. The functional configuration in the present embodiment is realized by a processor that executes arithmetic processing. As a processor that can be used for the present embodiment, a processor that is configured with any of various types of processing apparatuses, such as a single processor, a multiprocessor, and a multi-core processor, alone, and, additionally, a combination of any of the various types of processing apparatuses and a processing circuit such as an application specific integrated circuit (ASIC) or a field-programmable gate array (FPGA) are included.

Note that, in the present specification, the steps of describing the data processing executed by the mobile radio apparatus 1 and the mobile terminal apparatuses 2A and 2B include not only processes performed in order in a time series but also processes that are not necessarily performed in time series but are executed in parallel or individually.

An embodiment of the present disclosure has been described above. The embodiment is, however, a mere exemplification and does not limit the technical scope of the present disclosure. The present disclosure can be practiced in various other embodiments, and it is also possible to combine the configurations of the above embodiment and a modification thereof. Furthermore, it is possible to make various changes such as omission and replacement within a range not departing from the spirit of the present disclosure. Such embodiments and modifications thereof are included in the scope and spirit of the disclosure described in the present specification and the like and included in the disclosure described in Claims and a scope equivalent thereto.

What is claimed is:

1. A communication apparatus for performing communication with one or more external apparatuses in accordance with one wireless communication method, the communication apparatus comprising a processor and a non-transitory storage medium storing a program that causes the processor to:
perform, by transmitting search signals based on predetermined transmission timing rules in first communication that is an external apparatus search mode of the wireless communication method, communication with the one or more external apparatuses transmitting scan signals based on the predetermined transmission timing rules; and perform transmission or reception of contents data to or from the one or more external apparatuses by the first communication.

2. The communication apparatus according to claim 1, wherein the wireless communication method is Bluetooth Low Energy or Bluetooth Classic, and the first communication is advertising communication.

3. The communication apparatus according to claim 1, wherein, when receiving scan signals from a plurality of the external apparatuses in the first communication, the processor identifies the external apparatuses and performs transmission or reception of contents data to or from the external apparatuses in the first communication, based on the predetermined transmission timing rules.

4. The communication apparatus according to claim 1, wherein, when receiving scan signals from a plurality of the external apparatuses in the first communication, the processor identifies the external apparatuses, stores the identified external apparatuses and the predetermined transmission timing rules into a storage, associating the external apparatuses with the predetermined transmission timing rules and, when receiving scan signals from a plurality of the external apparatuses in the first communication, the processor reads correspondence relationships between the external apparatuses and the predetermined transmission timing rules from the storage.

5. The communication apparatus according to claim 1, wherein, when executing data communication faster than the first communication or predetermined data communication with one external apparatus of a plurality of the external apparatuses, the processor establishes connection by second communication in order to execute the data communication with the one external apparatus.

6. The communication apparatus according to claim 5, wherein the processor does not execute contents data communication by the first communication while executing the data communication with the one external apparatus by the second communication.

7. The communication apparatus according to claim 6, wherein, upon completion of the data communication with the one external apparatus by the second communication, the processor resumes contents data communication with a plurality of the external apparatuses including other external apparatuses by the first communication.

8. A communication method for a communication apparatus to perform communication with one or more external apparatuses in accordance with one wireless communication method, the communication method comprising:
causing a processor of the communication apparatus to perform, by transmitting search signals based on predetermined transmission timing rules in first communication for search for external apparatuses in the wireless communication method, communication with the one or more external apparatuses transmitting scan signals based on the predetermined transmission timing rules, and perform transmission or reception of contents data to or from the one or more external apparatuses by the first communication.

9. The communication method according to claim 8, wherein the wireless communication method is Bluetooth Low Energy or Bluetooth Classic, and the first communication is advertising communication.

10. The communication method according to claim 8, wherein, when receiving scan signals from a plurality of the external apparatuses in the first communication, the processor identifies the external apparatuses and performs transmission or reception of contents data to or from the external apparatuses in the first communication, based on the predetermined transmission timing rules.

11. The communication method according to claim 8, wherein, when receiving scan signals from a plurality of the external apparatuses in the first communication, the processor identifies the external apparatuses, stores the identified external apparatuses and the predetermined transmission timing rules into a storage, associating the external apparatuses with the predetermined transmission timing rules and, when receiving scan signals from a plurality of the external apparatuses in the first communication, the processor reads correspondence relationships between the external apparatuses and the predetermined transmission timing rules from the storage.

12. The communication method according to claim 8, wherein, when executing data communication faster than the first communication or predetermined data communication with one external apparatus of a plurality of the external apparatuses, the processor establishes connection by second communication in order to execute the data communication with the one external apparatus.

13. The communication method according to claim 12, wherein the processor does not execute contents data communication by the first communication while executing the data communication with the one external apparatus by the second communication.

14. A computer-readable non-transitory recording medium with a program recorded therein, the program causing a computer equipped in a communication apparatus that performs communication with one or more external apparatuses in accordance with one wireless communication method to execute a process comprising:
performing, by transmitting search signals based on predetermined transmission timing rules in first communication for search for external apparatuses in the wireless communication method, communication with the one or more external apparatuses transmitting scan signals based on the predetermined transmission timing rules; and executing transmission or reception of contents data to or from the one or more external apparatuses by the first communication.

15. The recording medium according to claim 14, wherein the wireless communication method is Bluetooth Low Energy or Bluetooth Classic, and the first communication is advertising communication.

16. The recording medium according to claim 14, wherein the computer is caused to, when receiving scan signals from a plurality of the external apparatuses in the first communication, identify the external apparatuses and perform transmission or reception of contents data to or from the external apparatuses in the first communication, based on the predetermined transmission timing rules.

17. The recording medium according to claim 14, wherein the computer is caused to, when receiving scan signals from a plurality of the external apparatuses in the first communication, identify the external apparatuses, store the identified external apparatuses and the predetermined transmission timing rules into a storage, associating the external apparatuses with the predetermined transmission timing rules and, when receiving scan signals from a plurality of the external apparatuses in the first communication, read correspondence relationships between the external apparatuses and the predetermined transmission timing rules from the storage.

18. The recording medium according to claim 14, wherein the computer is caused to, when executing data communication faster than the first communication or predetermined data communication with one external apparatus of a plurality of the external apparatuses, establish connection by second communication in order to execute the data communication with the one external apparatus.

19. The recording medium according to claim 18, wherein the computer is not caused to execute contents data communication by the first communication while executing the data communication with the one external apparatus by the second communication.
